(19) United States
(12) Patent Application Publication
(10) Pub. No.: US 2003/0086153 A1
(43) Pub. Date: May 8, 2003

(54) Method and apparatus for setting gain and tilt in spectral performance of fiber amplifiers

(75) Inventors: Idan Mandelbaum, Piscataway, NJ (US); Martin Achtenhagen, Bradley Beach, NJ (US); Donald R. Zimmerman, Farmingdale, NJ (US); Stephen W. Arleth, Farmingdale, NJ (US); Kao Yang Huang, Plainsboro, NJ (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/286,323

(22) Filed: Nov. 1, 2002

Related U.S. Application Data
(60) Provisional application No. 60/335,471, filed on Nov. 2, 2001.

(51) Int. Cl. H01S 3/00

(52) U.S. Cl. 359/337.1

(57) ABSTRACT

An apparatus for sensing changes, e.g. transient changes in the input or output signal spectrum of an optical amplifier, typically an EDFA, uses only a pair of spectrally banded photodiodes to equalize the transient behaviour of the amplifier. The photodiodes provide a control signal which is either sum or difference of signals generated by the photodiodes, that is used in the control of the optical amplifier in a feedback or feed-forward mode in order to counterbalance the effects of changes in the spectral content of the input (or output) signal of the optical amplifier.

### RELATED APPLICATIONS

This application claims priority from U.S. provisional application No. 60/335,471 filed Nov. 2, 2001.

### TECHNICAL FIELD

This invention relates to fiber amplifiers, and more specifically, to a method and apparatus for sensing and correcting the spectral performance, such as changes in the spectral power level distribution (gain and tilt) in the optical signal passing through an optical amplifier.

### BACKGROUND ART

The distance between optical terminals in an optical transmission system is limited by the optical power that can be launched into an optical fiber, by losses in the fiber and in the accompanying elements, devices and systems, and by dispersion in the optical fiber. For this reason, optical amplifiers are provided in the optical transmission line. Optical amplifiers are typically erbium doped fiber amplifiers (EDFAs) which have many well known advantages.

The gain of an EDFA however, varies strongly with wavelength. Thus a problem occurs when the signal input comprises light signals on several different wavelength channels. The preferred operating condition for the amplifier is that the output signal power level from the amplifier for each wavelength channel is equal. Thus the gain of the EDFA is preferably equalized so that it is flat over the spectral region occupied by the WDM wavelength channels. The variation of amplifier gain with wavelength is known as gain ripple. The minimization of the gain ripple of an EDFA is achieved using equalization techniques such as those disclosed in U.S. Pat. No. 5,764,406 in the name of Newhouse et al. entitled Hybrid Optical Amplifier Dynamic Gain Tilt and in U.S. Pat. No. 6,268,954 in the name of Yihao Cheng entitled Method and System for Controlling the Slope of an Output Response.

Since a change in power level of the signal input to the amplifier for one wavelength channel affects the gain at the other wavelength, a problem occurs when wavelength channels are added to, or dropped from, the WDM lightwave signal input to the amplifier. The amplifier gain must be adjusted dynamically to obtain optimum performance for the new signal input conditions. A goal of the invention is to disclose a means for detecting, reasonably simply, changes that occur in the spectral distribution of the light signal input power level to an optical amplifier with sufficient rapidity to detect transient changes.

It is desirable to detect dynamically the changes, both transient and constant, in the spectral distribution of the power level of the signal input to the optical amplifier. Prior art means consist of tapping portion of the signal input and measuring using a spectrum analyzer the relative power levels of the wavelength channels in the input light signal. Such a means is complex because it requires demultiplexing the signal and detecting the power level in each wavelength channel. It is also costly because it requires a WDM demultiplexer and a spectrum analyzer. The response time of the control system is also low unless the spectrum analyzer has the capability to measure simultaneously the power levels in each wavelength channel. A control means for an optical amplifier to suppress changes in the input power signal requires means for sensing changes instantaneously in the spectral content of the input signal to the amplifier. The information of the spectral content of the input signal is then passed to an amplifier control means, which computes, using an algorithm, how to adjust the amplifier to the new signal input conditions.

### SUMMARY OF THE INVENTION

Transient control algorithms for EDFAs using pump control require channel-loading (wavelength dependence) input. It means that in order to be able to control the gain and tilt in an EDFA, some spectral information is needed to determine the control scheme.

In accordance with the present invention, the spectral information is obtained using a pair of spectrally different photodetectors (i.e. having each a different spectral response), for example spectrally banded photodiodes.

Offset error is the ratio between the desired gain setting and the actual gain setting of a controlled amplifier. It has been found that by using a control system with banded detectors, a reduction of up to 30% in offset error can be achieved. This finding is of importance as it demonstrates that by determining the wavelength center of mass of the input signal, amplifier performance can be improved.

In accordance with one aspect of the invention, there is provided an apparatus for correcting the gain and tilt properties of in an optical signal passing through an optical amplifier, or amplifier means, the apparatus comprising:

at least two spectrally different photodetectors for detecting spectral properties of the input optical signal and for generating a first spectral signal indicative of the spectral properties of the optical signal, control means responsive to the first spectral signal and for producing a control signal for controlling the amplifier in response to the first spectral signal, and

means for controlling the gain and tilt of the amplifier in dependence upon the control signal.

At least one of the photodetectors may be a banded photodetector.

The optical signal may be an optical signal at the input to the optical amplifier, wherein the apparatus functions in a feed-forward mode. Alternatively, the optical signal may be an optical signal at the output of the optical amplifier (feed-back mode), or optical signals both at the input and at the output of the optical amplifier may be used for the analysis.

In one embodiment of the invention, the apparatus may be used to compensate for the effects of spectral transients in the amplifier's input optical signal.

In an embodiment of the invention, the two photedetectors may be photodetectors for generating also a first power signal indicative of a total power of the input optical signal. The first power signal may be used to control an optical attenuator coupled with the amplifier, and the apparatus may comprise control means for controlling the optical attenuator, the control means coupled to receive the first power signal.

The amplifier means denotes two or more optical amplifiers coupled in a sequence or tandem.

In accordance with another aspect of the invention, there is provided a method for detecting the gain and tilt in the spectral content of an optical signal passing through at least one optical amplifier and for providing a control signal for the optical amplifier, the method comprising:

detecting spectral properties of the optical signal passing through the optical amplifier and generating a first spectral signal indicative of the properties using two spectrally different photodetectors,

generating at least a first control signal as a function of the first spectral signal, and

controlling a spectral profile of the amplifier in dependence upon the first control signal.

In an embodiment of the invention, the optical signal is an input signal of the optical amplifier. In another embodiment of the invention, the optical signal is an output signal of the amplifier. In yet another embodiment of the invention, both input and output signals are analyzed. Correspondingly, the method may comprise the step of generating more than one control signal as a function of the spectral signals, and the step of controlling the spectral profile of the amplifier in dependence upon the control signals.

### BRIEF DESCRIPTION OF THE DRAWINGS

The invention will be explained in more detail by way of the following description in conjunction with the drawings in which

FIG. 1 is a block diagram of a banded photodiode unit,

FIG. 2 is a schematic representation of an embodiment of the apparatus for compensating for transients of EDFA,

FIG. 3 illustrates a feed-forward configuration of the pump control unit of FIG. 2,

FIG. 4 illustrates a feed-forward—feedback configuration of the pump control unit of FIG. 2, and

FIG. 5 illustrates an arrangement for controlling the gain and tilt of an EDFA

### DETAILED DESCRIPTION OF THE EMBODIMENTS OF THE INVENTION

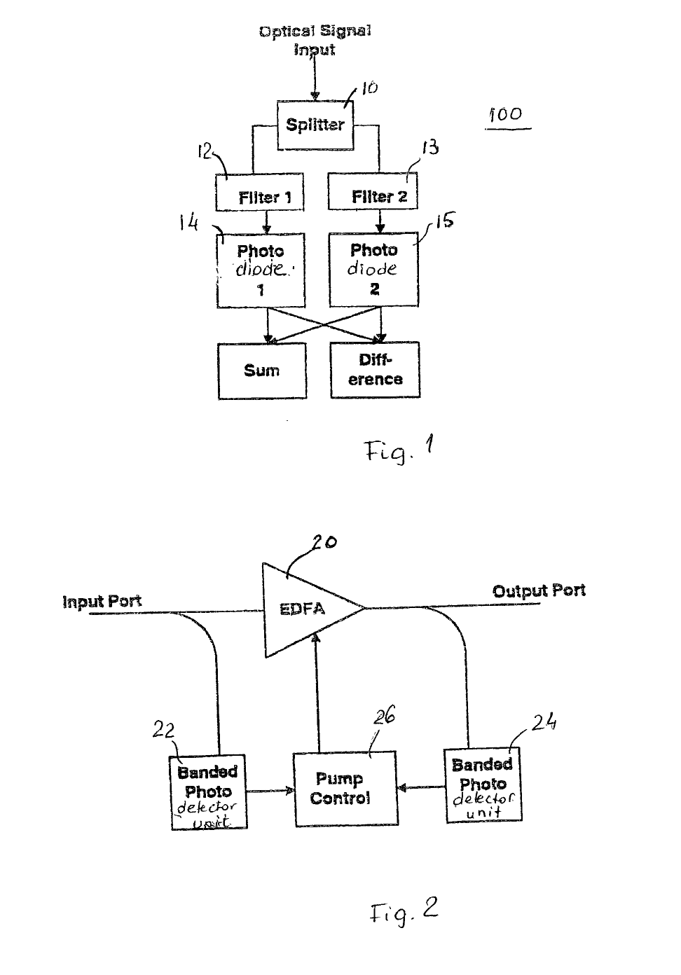

FIG. 1 shows a block diagram of a spectrally banded photodiode (SBPD) unit 100. The spectrally banded photodiode (SBPD) unit has a pair of photodiodes 12, 13, one or both of which having a spectrally selective filter associated therewith, preferably at its input. Spectral information about an optical signal incident on the photodiodes can be determined from the sum or difference in responses of the two diodes. If both photodiodes are provided with a filter, the filters are dissimilar. In one embodiment the portion of the spectrum passing one filter is blocked by the other. The filter or filters can be of any kind as long as they cover the band of interest and have a proper shape to resolve spectral changes of interest.

The SBPD unit 100 has a splitter 10 for splitting an input optical signal into two streams, each fed through a filter 12, 13 to a photodiode (photodetector) 14, 15. The photodiodes 14, 16 are interconnected to enable their input to be analyzed as a sum or as a difference of inputs. To that effect, a control unit, not shown in FIG. 1, may be provided.

Through the above-described arrangement, the banded photodiode unit 100 can give a voltage output proportional to the weighted sum of the power at each wavelength where the weight is determined by the filter. By combining two such photodiodes, the difference signal between the diodes can be used to determine spectral information.

As an alternative of the embodiment illustrated, one filter can be removed thus leaving one banded photodiode and one regular photodiode, in order to make the device less sensitive to temperature. This is done by ignoring the sum of signals and using the output of the un-banded (regular) photodiode to determine the power signal and the difference between the outputs of the regular and the banded photodiode to form the spectral signal. Since there are fewer components between the diode and the power signal, the total amplifier power can be read more accurately and thus the control method can function more accurately.

FIG. 2 represents one general embodiment of an apparatus for compensating for input signal level transients or amplifier gain tilt. As shown in FIG. 2, optical signal is tapped (tap not specifically referenced) before and after the amplifier (EDFA) 20 and fed to a spectrally banded photodiode unit 22 and SBPD unit 24 respectively. The outputs of the SBPD units 22 and 24 are provided to a pump control unit 26 that in turn controls pump laser of the EDFA 20.

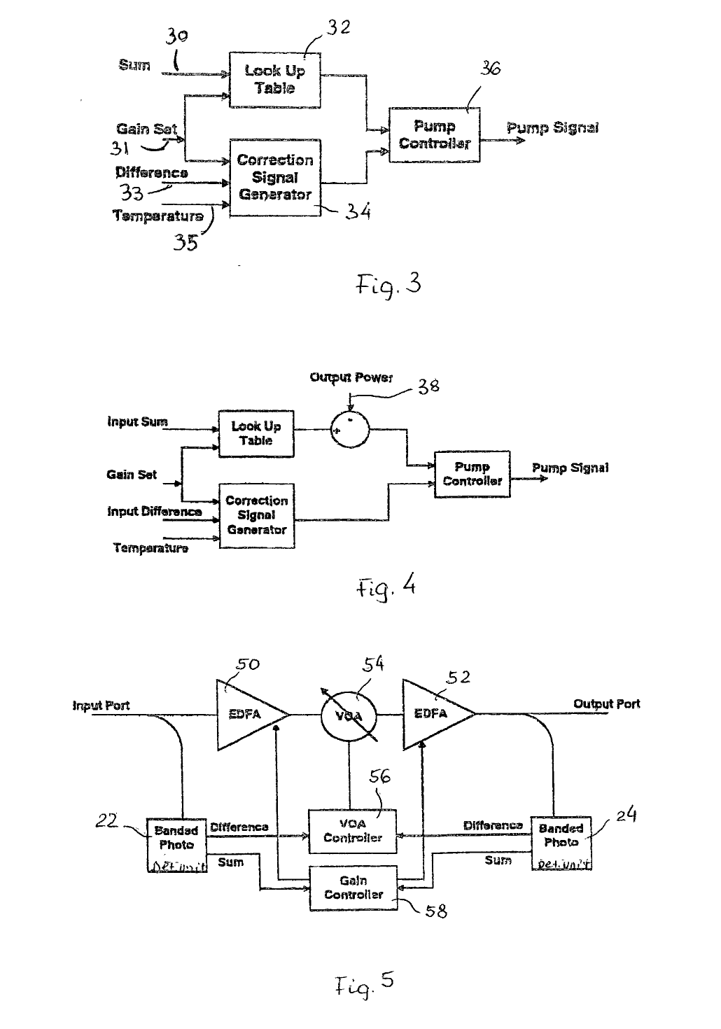

FIG. 3 shows an exemplary feed-forward configuration of the pump control unit 26 of FIG. 2, the configuration operative to suppress the effects of input signal transients on the performance of an EDFA. The sum portion 30 of the output of the SBPD unit 22 and a gain set signal 31 which is a user set signal for the gain requirement are used in a look-up table algorithm 32 to determine pump settings.

In operation, when a transient occurs, the difference signal 33 from SBPD unit 22 will sense which part of the spectrum the transient occurs in and provides an appropriate correction signal through a correction signal generator 34 to the pump controller 36. A temperature input 35 is provided to the generator 34 to compensate for the temperature sensitivity of the EDFA response.

FIG. 4 illustrates an exemplary feed-forward/feed-back configuration of the pump control unit 26, the configuration operative to suppress the effects of signal input transients on an EDFA. The configuration functions similarly as that of FIG. 3 but includes a feedback from the signal output side (photodetector unit 24) of the EDFA 20 in the form of a total output power signal 38 which can be obtained from an unbanded photodiode or from the sum signal of an SBPD. The difference between the output power obtained and desired output power is used to set the pumps for the proper gain of the amplifier.

In FIG. 5, two SBPD units 22, 24 are used in setting the gain and tilt of an EDFA unit consisting of two optical amplifiers 50, 52. An output from each SBPD unit 22, 24 is linked to controller 56 of a variable optical attenuator (VOA) 54 located between the two optical amplifiers. The VOA controller 56 is provided to receive and analyze the difference signals from both the input and output in order to adjust the tilt. The correct setting is determined by noting which difference is higher and adjusting pump powers to compensate. The tilt can then be set by changing the attenuator setting until the desired gain levels are achieved in both difference signals. An output from the two banded photodiodes is also linked to gain controller 58.

For clarification, each banded photodiode has a sum and a difference output. Where the term “the ratio of the sum” is used, it means the sum output of a first SBPD unit divided by the sum output of the second SBPD unit. The sum output of both SBPD units 22, 24 is used to adjust the gain by modifying pump power proportionally to the ratio of sum outputs of the SBPD units. This can be done in both feedback and feed-forward configuration.

The components of the apparatus are easily available. For instance, the photodiodes are GaAs type, available from JDS Uniphase. The attenuator is available from the same source. Erbium doped fiber amplifiers are also widely available. The control system can be an analog system or a DSP type, the latter available e.g. from Texas Instruments.

To summarize, the invention proposes the use of a photodiode pair configured to produce sum and difference signals to separate out power and spectral effects. In essence, the invention is analogous to a low-resolution optical channel monitor in that it enables the measurement of the spectral content of the input signals and the output signals thereby providing spectral information that can be used to adjust the amplifier gain to compensate for transient changes in input signal power levels.

It is conceivable to produce the diode pair and the filter(s) in a monolithic manner and incorporate the assembly into an amplifier as a component with relatively little added cost beyond the cost of a simple tap.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Numerous other embodiments of the invention are conceivable without departing from the scope of the invention as defined in the appended claims.

1. A method for correcting the gain and tilt in the spectral content of an optical signal passing through at least one optical amplifier, and for providing a control signal for controlling the amplifier gain and tilt, the method comprising:
detecting spectral properties of the optical signal passing through the optical amplifier and generating a first spectral signal indicative of the properties using two spectrally different photodetectors,
generating at least a first control signal as a function of the first spectral signal, and
controlling a spectral profile of the amplifier in dependence upon the first control signal.

2. The method of claim 1 wherein the optical signal is an input signal of the optical amplifier.

3. The method of claim 1 wherein the optical signal is an output signal of the optical amplifier.

4. A method for correcting the gain and tilt in the spectral content of an optical signal passing through at least one optical amplifier, and for providing a control signal for controlling the amplifier gain and tilt, the method comprising:
measuring a first spectral signal at an input of an optical amplifier,
measuring a second spectral signal at an output of the optical amplifier,
generating at least a first control signal as a function of the first and second spectral signal, and
controlling the gain of the amplifier in dependence upon the first control signal.

5. The method of claim 1 wherein the function is a difference between the first and the second spectral signal.

6. The method of claim 1 wherein the function is a sum of the first and second spectral signal.

7. An apparatus for correcting the gain and tilt of an optical amplifier or amplifier means, the apparatus comprising:
at least two spectrally different photodetectors for detecting spectral properties of an optical signal passing through the amplifier and for generating a first sensing signal indicative of the spectral properties of the optical signal, control means responsive to the first sensing signal and for producing a control signal for controlling the amplifier in response to the first sensing signal, and
means for controlling the gain and tilt of the amplifier in dependence upon the control signal.

8. The apparatus according to claim 7 wherein the two photedetectors are photodetectors for further generating a second sensing signal indicative of a total power of the input optical signal.

9. The apparatus according to claim 7 further comprising an optical attenuator coupled with the optical amplifier, the apparatus also comprising control means for controlling the optical attenuator, the control means coupled to receive the second sensing signal.

10. The apparatus of claim 7 wherein an output of each photodetector is provided to the control means for adjusting the gain and tilt of the optical amplifier by modifying pump power in dependence upon the ratio of outputs of the photodetectors.

11. The apparatus of claim 7 wherein the at least two spectrally different photodetectors are coupled to an output port of the optical amplifier and the control signal is provided in feedback mode.

12. The apparatus of claim 7 wherein the at least two spectrally different photodetectors are coupled to an input port of the optical amplifier and the control signal is provided in feed-forward mode.

13. The apparatus of claim 7 wherein at least two spectrally different photodetectors are coupled to an input port of the optical amplifier and at least two spectrally different photodetectors are coupled to an output port of the amplifier.

14. The apparatus of claim 7 further comprising a tap for tapping a portion of the optical signal passed through the amplifier and an optical splitter for splitting the tapped portion of the optical signal into sub-beams, each sub-beam coupled to one of the photodiodes.

15. The apparatus according to claim 7 comprising two or more amplifiers coupled in tandem.

16. The apparatus according to claim 7 wherein at least one of the photodetectors is a spectrally banded photodiode.
